(19) United States
(12) Patent Application Publication
(10) Pub. No.: US 2024/0316916 A1
(43) Pub. Date: Sep. 26, 2024

(54) SCREEN PRINTING MACHINE AND SCREEN PRINTING METHOD

(71) Applicants: Jen-Che TSENG, Taichung City (TW); BUILT-IN PRECISION MACHINE CO., LTD., Taichung City (TW)

(72) Inventor: Jen-Che TSENG, Taichung City (TW)

(21) Appl. No.: 18/494,406

(22) Filed: Oct. 25, 2023

(30) Foreign Application Priority Data
Mar. 24, 2023 (TW) 112202716

(51) Int. Cl. B41F 15/34

(52) U.S. Cl. CPC B41F 15/34

(57) ABSTRACT

A screen printing machine includes a machine frame, a moving unit disposed at the base and including a sliding platform, a supporting unit disposed at the sliding platform, and a printing unit including a carrier. The machine frame includes a base, a blade assembly located above the base, and a screen located between the blade assembly and the base. The sliding platform is movable in a length direction of the machine frame. The carrier is located between the screen and the supporting unit and is connected to the supporting unit. When the supporting unit drives the carrier to rotate from a first printing position to a second printing position about a first axis, the sliding platform moves from a first length position to a second length position in the length direction.

### RELATED APPLICATIONS

This application claims priority to Taiwan Application Serial Number 112202716, filed Mar. 24, 2023, which is herein incorporated by reference.

### BACKGROUND

### Technical Field

The present disclosure relates to a printing machine and a printing method. More particularly, the present disclosure relates to a screen printing machine and a screen printing method.

### Description of Related Art

Generally speaking, a conventional screen printing machine includes a blade, a screen and a printing stage. A to-be-printed article may be put between the printing stage and the screen during printing, the ink may be coated on the screen, and then the blade scraps the ink off the screen to allow the ink to be uniformly printed on the to-be-printed article to finish the printing.

However, the conventional screen printing machine may be only adapted to print the to-be-printed article having a flat shape. If the to-be-printed article having a various curve is printed, the track of the blade has to be adjusted according to the surface of the to-be-printed article. Therefore, in one method, a specific linking structure may be disposed at the blade to adjust the angle of the blade; however, the cost is high and the technique thereof is difficult, and the to-be-printed article is not well printed. In another method, the to-be-printed article may be rotated by a rotary spindle, but as the radius of the to-be-printed article is changed, the position of the blade cannot be adjusted correspondingly, and the difficulty of the printing is increased, thereby lowering the printing accuracy.

Based on the abovementioned problems, how to improve the structure of the screen printing machine to increase the printing accuracy as printing on the to-be-printed article having various radiuses becomes a target that those in the industry pursue.

### SUMMARY

According to one aspect of the present disclosure, a screen printing machine includes a machine frame, a moving unit disposed at the base and including a sliding platform, a supporting unit disposed at the sliding platform, and a printing unit including a carrier. The machine frame includes a base, a blade assembly located above the base, and a screen located between the blade assembly and the base. The sliding platform is movable in a length direction of the machine frame. The carrier is located between the screen and the supporting unit and is connected to the supporting unit. When the supporting unit drives the carrier to rotate from a first printing position to a second printing position about a first axis, the sliding platform moves from a first length position to a second length position in the length direction.

According to another aspect of the present disclosure, a screen printing method includes a to-be-printed article placing step, a first printed-surface printing step, a carrier adjusting step and a second printed-surface printing step. In the to-be-printed article placing step, a to-be-printed article is placed at a carrier of a printing unit of a screen printing machine. In the first printed-surface printing step, a blade assembly of the screen printing machine scrapes an ink off a screen, and one portion of a pattern on the screen is printed on a first printed-surface of the to-be-printed article. In the carrier adjusting step, a supporting unit connected to the carrier is driven to rotate the carrier from a first printing position to a second printing position about a first axis, and a sliding platform disposed at a machine frame is moved from a first length position to a second length position in a length direction and is linked with the carrier, thereby allowing a second printed-surface of the to-be-printed article to face toward the screen. In the second printed-surface printing step, the blade assembly of the screen printing machine scrapes the ink off the screen, and another portion of the pattern on the screen is printed on the second printed-surface of the to-be-printed article.

### BRIEF DESCRIPTION OF THE DRAWINGS

The disclosure can be more fully understood by reading the following detailed description of the embodiments, with reference made to the accompanying drawings as follows:

FIG. 1 shows a three-dimensional schematic combined view of a screen printing machine of a first embodiment of the present disclosure.

FIG. 2 shows a top view of the screen printing machine of the first embodiment in FIG. 1.

FIG. 3 shows a partial exploded view of the screen printing machine of the first embodiment in FIG. 1.

FIG. 4 shows a partial exploded view of the screen printing machine of the first embodiment in FIG. 3.

FIG. 5 shows another partial exploded view of the screen printing machine of the first embodiment in FIG. 3 taken from another view angle.

FIG. 6 shows a cross-sectional view of the screen printing machine of the first embodiment in FIG. 2 taken along line VI-VI.

FIG. 7 shows a cross-sectional view of the screen printing machine of the first embodiment in FIG. 2 taken along line VII-VII.

FIG. 8 shows one side view of the screen printing machine of the first embodiment in FIG. 1.

FIG. 9 shows an operating flow of the screen printing machine of the first embodiment in FIG. 1.

FIG. 10 shows another side view of the screen printing machine of the first embodiment in FIG. 1.

FIG. 11 shows yet another side view of the screen printing machine of the first embodiment in FIG. 1.

FIG. 12 shows a side view of a screen printing machine according to a second embodiment of the present disclosure.

FIG. 13 shows a side view of a screen printing machine according to a third embodiment of the present disclosure.

FIG. 14 shows a block flow chart of a screen printing method according to a fourth embodiment of the present disclosure.

### DETAILED DESCRIPTION

It will be understood that when an element (or mechanism or module) is referred to as being “disposed on”, “connected to” or “coupled to” another element, it can be directly disposed on, connected or coupled to the other element, or intervening elements may also be present. In contrast, when an element is referred to as being “directly disposed on”, “directly connected to” or “directly coupled to” another element, there are no intervening elements present.

In addition, the terms first, second, third, etc. are used herein to describe various elements or components, these elements or components should not be limited by these terms. Consequently, a first element or component discussed below could be termed a second element or component.

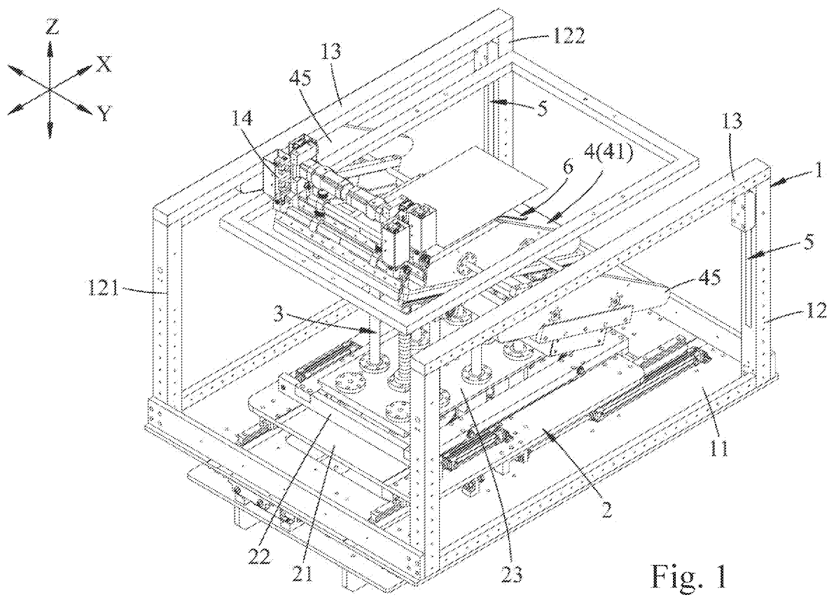

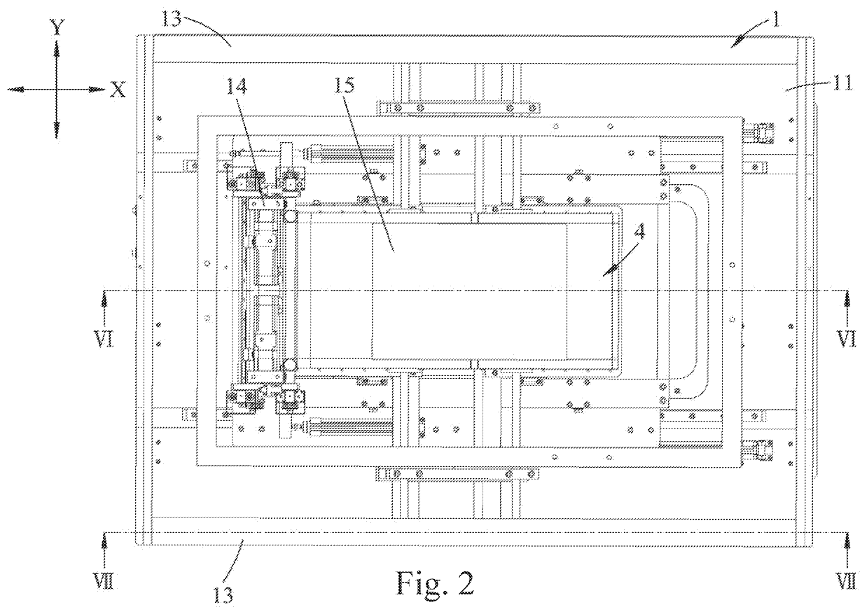

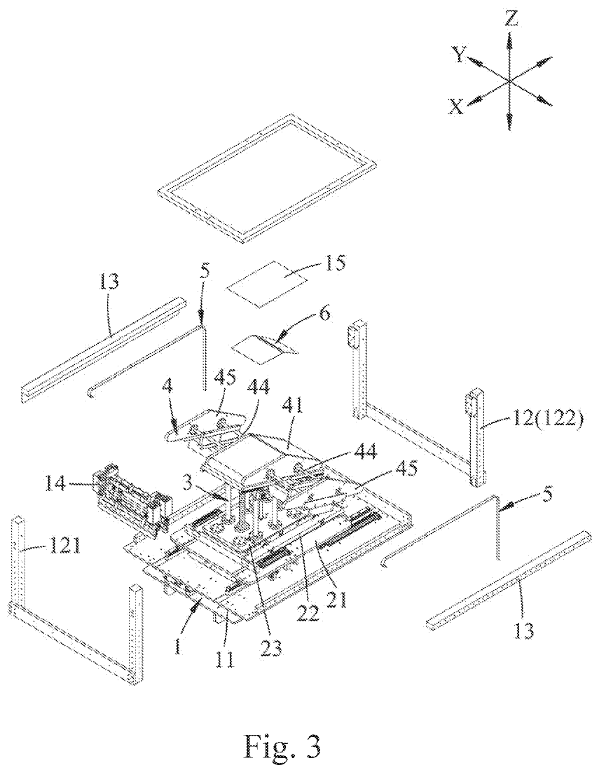

FIG. 1 shows a three-dimensional schematic combined view of a screen printing machine of a first embodiment of the present disclosure. FIG. 2 shows a top view of the screen printing machine of the first embodiment in FIG. 1. FIG. 3 shows a partial exploded view of the screen printing machine of the first embodiment in FIG. 1. The screen printing machine is applied to print a pattern onto a to-be-printed article 6 having different printed-surfaces. The screen printing machine includes a machine frame 1, a moving unit 2, a supporting unit 3 and a printing unit 4.

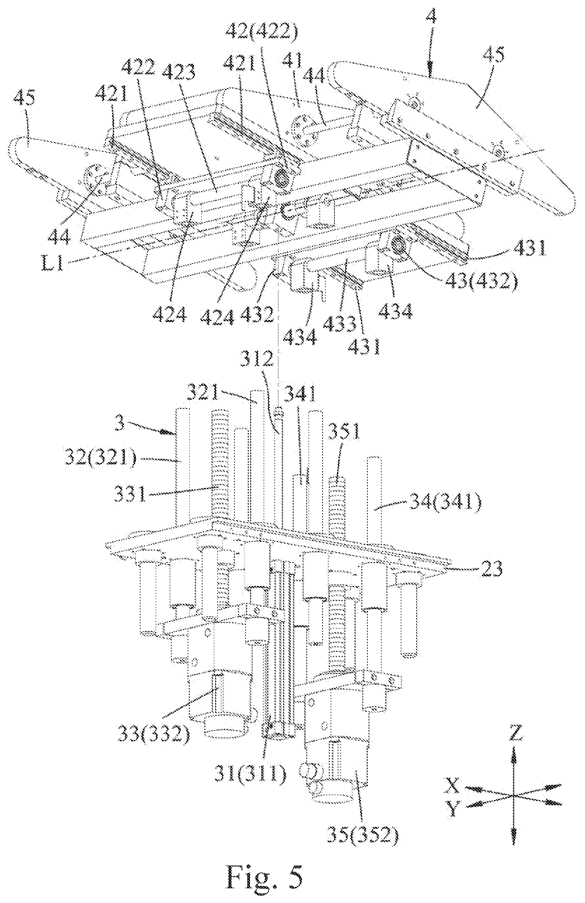

The machine frame 1 includes a base 11, a blade assembly 14 located above the base 11, and a screen 15 located between the blade assembly 14 and the base 11. The moving unit 2 is disposed at the base 11 and includes a sliding platform 23, and the sliding platform 23 is movable in a length direction X of the machine frame 1. The supporting unit 3 is disposed at the sliding platform 23. The printing unit 4 includes a carrier 41, and the carrier 41 is located between the screen 15 and the supporting unit 3 and is connected to the supporting unit 3. When the supporting unit 3 drives the carrier 41 to rotate from a first printing position to a second printing position about a first axis L1 (labeled in FIG. 5 and being parallel to a width direction Y of the machine frame 1), the sliding platform 23 moves from a first length position to a second length position in the length direction X.

Therefore, with that the supporting unit 3 rotates the carrier 41 to allow different printed-surfaces of the to-be-printed article 6 to face upward, there is no need to adjust the angle of the blade assembly 14. Moreover, with that the movement of the moving unit 2 can adjust the position of the to-be-printed article 6 in the length direction X, the to-be-printed article 6 is prevented from not corresponding to the blade assembly 14, and the printing accuracy may be increased. The details of the screen printing machine are described hereinafter.

The base 11 is substantially rectangular, and the machine frame 1 may further include a frame body 12 and two horizontal frames 13. The frame body 12 is disposed at the base 11, and the two horizontal frames 13 are disposed at the frame body 12 with an interval in the width direction Y of the machine frame 1.

The machine frame 12 has a first frame 121 and a second frame 122. The first frame 121 and the second frame 122 are both U-shaped and are disposed at the frame body 12 with an interval in the length direction X of the base 11. Each horizontal frame 13 is extendedly disposed between the first frame 121 and the second frame 122 in the length direction Y. The screen 15 extends in the length direction X and the width direction Y.

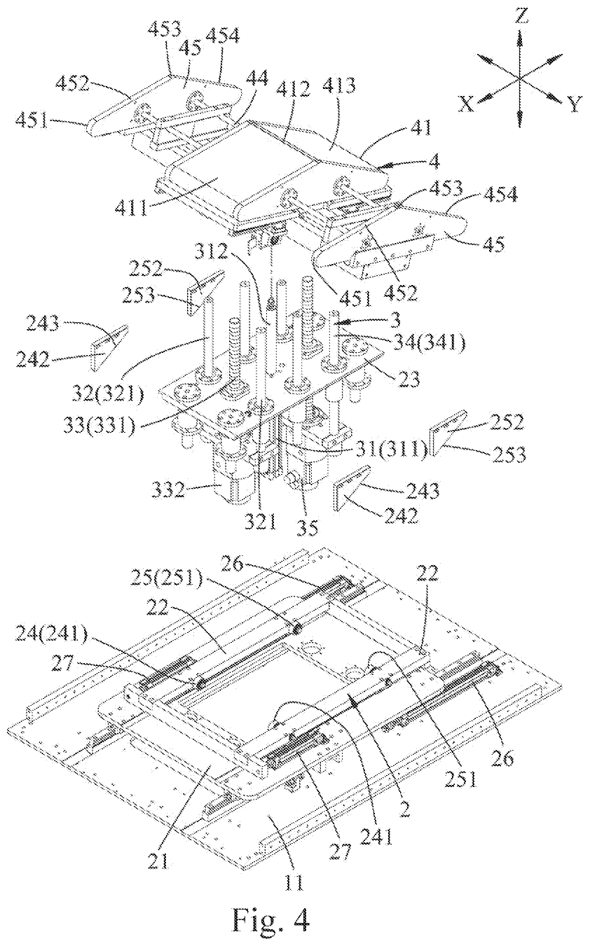

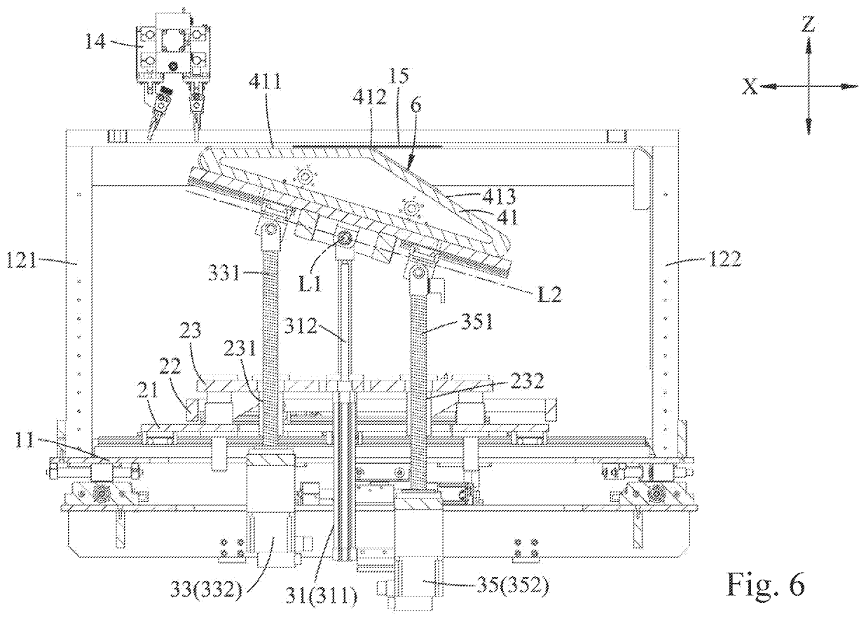

FIG. 4 shows a partial exploded view of the screen printing machine of the first embodiment in FIG. 3. FIG. 5 shows another partial exploded view of the screen printing machine of the first embodiment in FIG. 3 taken from another view angle. FIG. 6 shows a cross-sectional view of the screen printing machine of the first embodiment in FIG. 2 taken along line VI-VI. Please refer to FIGS. 4 to 6 with references of FIGS. 2 to 3, the moving unit 2 is disposed at the base 11 and includes a platform 21, a frame member 22, a first guiding assembly 24, a second guiding assembly 25, two first telescopic rods 26 and two second telescopic rods 27.

The platform 21 is disposed at the base 11 and is movable in the length direction X. The frame member 22 is disposed at the platform 21, the sliding platform 23 is disposed at the frame member 22, and the sliding platform 23 has a first inner threaded hole 231 and a second inner threaded hole 232. The first inner threaded hole 231 and the second inner threaded hole 232 extend in a height direction Z and are arranged with an interval in the length direction X.

The first guiding assembly 24 includes two first guiding members 241 and two first guiding boards 242, the two first guiding members 241 are disposed at the frame member 22 with an interval in the width direction Y, and the two first guiding boards 242 are respectively disposed at two sides of the sliding platform 23 opposite in the width direction Y. Each first guiding board 242 has a first guiding surface 243 that is inclined from upper right to lower left abutting downward against the first guiding member 241 corresponding thereto. The second guiding assembly 25 includes two second guiding members 251 and two second guiding boards 252, the two second guiding members 251 are disposed at the frame member 22 with an interval in the width direction Y, and the two second guiding boards 252 are respectively disposed at two sides of the sliding platform 23 opposite in the width direction Y. Each second guiding board 252 has a second guiding surface 253 that is inclined from upper right to lower left abutting downward against the second guiding member 251 corresponding thereto. In the embodiment, each of the first guiding members 241 and the second guiding members 251 is a roller.

The two first telescopic rods 26 are respectively disposed at two sides of the based 11 opposite in the width direction Y. Each first telescopic rod 26 is telescopically disposed between the base 11 and the platform 21 in the length direction X. The two second telescopic rods 27 are respectively disposed at two sides of the platform 21 opposite in the width direction Y. Each second telescopic rod 27 is telescopically disposed between the platform 21 and the frame member 22 in the length direction X. The first telescopic rods 26 and the second telescopic rods 27 may slow the speed of the sliding platform 23 and the platform 21 as moving in the length direction X.

The supporting unit 3 includes a first supporting member 32 penetrating the sliding platform 23 and pivotally connected to the carrier 41, a first driving member 33 disposed at the sliding platform 23 and being elevatable relative to the sliding platform 23 in the height direction Z, a second supporting member 34 penetrating the sliding platform 23 and pivotally connected to the carrier 41, the second supporting member 34 being spaced apart from the first supporting member 32 in the length direction X, and a second driving member 35 disposed at the sliding platform 23 and being elevatable relative to the sliding platform 23 in the height direction Z. The first driving member 33 is lowered relative to the sliding platform 23 to lower the first supporting member 32 relative to the sliding platform 23, and the second driving member 35 is lifted relative to the sliding platform 23 to lift the second supporting member 34 relative to the sliding platform 23, thereby allowing the carrier 41 to rotate from the first printing position to the second printing position. The supporting unit 3 may further include a central supporting member 31 penetrating the sliding platform 23 and pivotally connected to a center of the carrier 41.

As shown in FIGS. 4 and 5, the central supporting member 31 is a damper and includes a central pressure cylinder 311 and a central supporting rod 312. The central pressure cylinder 311 is disposed below the sliding platform 23, and the central supporting rod 312 is movably and insertably disposed at the central pressure cylinder 311 and passes through the sliding platform 23. The first supporting member 32 is located at one side of the central supporting member 31 in the length direction X, and the second supporting member 34 is located at the other side of the central supporting member 31 opposite to the first supporting member 32 in the length direction X. In the first embodiment, the first supporting member 32 is located at a left side of the central supporting member 31, and the second supporting member 34 is located at a right side of the central supporting member 31. In other embodiments, the first supporting member may be located at the right side of the central supporting member, and the second supporting member may be located at the left side of the central supporting member.

The first driving member 33 has a first screwing rod 331 and a first motor 332. The first screwing rod 331 is screwed with the first inner threaded hole 231, and the first motor 332 is located below the sliding platform 23 and rotates the first screwing rod 331. The first supporting member 32 has two first supporting rods 321, the two first supporting rods 321 penetrate the sliding platform 23 and are connected to the first motor 332, and the two first supporting rods 321 are respectively located at two sides of the first screwing rod 331 opposite in the width direction Y. The supporting unit 3 may further include a first connecting rod connected to the two first supporting rods 321 and the first screwing rod 331 in the width direction Y, and as the first screwing rod 331 is lifted or lowered, the first supporting rods 321 may be lifted or lowered correspondingly.

The second driving member 35 has a second screwing rod 351 and a second motor 352. The second screwing rod 351 is screwed with the second inner threaded hole 232, and the second motor 352 is located below the sliding platform 23 and rotates the second screwing rod 351. The second supporting member 34 has two second supporting rods 341, the two second supporting rods 341 penetrate the sliding platform 23 and are connected to the second motor 352, and the two second supporting rods 341 are respectively located at two sides of the second screwing rod 351 opposite in the width direction Y. The supporting unit 3 may further include a second connecting rod connected to the two second supporting rods 341 and the second screwing rod 351 in the width direction Y, and as the second screwing rod 351 is lifted or lowered, the second supporting rods 341 may be lifted or lowered correspondingly.

It is noted that, in the first embodiment, the first driving member 33 and the second driving member 35 are taken as motors for example, but the present disclosure is not limited thereto. In other embodiments, the first driving member and the second driving member may employee pneumatic cylinders or other technique suitable for moving elements.

As shown in FIGS. 3 to 5, the printing unit 4 is disposed between the two horizontal frames 13 in the width direction Y, and the printing unit 4 may further include a first sliding member 42 and a second sliding member 43. The first sliding member 42 includes two first rails 421 disposed at the carrier 41 with an interval in the width direction Y, two first sliders 422 respectively disposed at the two first rails 421, and a first pivoting rod 423 rotably connected between the two first sliders 422 and being configured for the first supporting member 32 to be disposed thereon. The second sliding member 43 includes two second rails 431 disposed at the carrier 41 with an interval in the width direction Y with that each of the second rails 431 is spaced apart from each of the first rails 421 in the length direction X, two second sliders 432 respectively disposed at the two second rails 431, and a second pivoting rod 433 rotably connected between the two second sliders 432 and being configured for the second supporting member 34 to be disposed thereon.

Precisely, the carrier 41 is disposed above the supporting unit 3 and is pivotally connected to one end of the central supporting rod 312 that is away from the central pressure cylinder 311. The carrier 41 has a first side surface 411, a central surface 412 and a second side surface 413 from left to right in order. The central surface 412 is connected between the first side surface 411 and the second side surface 413. The first side surface 411, the central surface 412 and the second side surface 413 together form the top surface facing upward to the screen 15, and a cross-sectional surface boundary perpendicular to the width direction (parallel to the surface formed by the length direction Y and the height direction Z) is an inverted V-shape.

The first pivoting rod 423 may be connected to two first mounting brackets 424, and each first supporting rod 321 is disposed at each first mounting bracket 424. The second pivoting rod 433 may be connected to two second mounting brackets 434, and each second supporting rod 341 is disposed at each second mounting bracket 434. Therefore, each first supporting rod 321 and each second supporting rod 341 are respectively pivotally connected to the first sliding member 42 and the second sliding member 43. Consequently, with that the carrier 41 is pivotally connected to the central supporting member 31, the first sliding member 42 is pivotally connected to the first supporting member 32, the second sliding member 43 is pivotally connected to the second supporting member 34, and the carrier 41 may rotate about the first axis L1. Moreover, with the configuration of the first sliding member 42 and the second sliding member 43, the carrier 41 may be moved in a second axis L2, being orthogonal to the first axis L1, relative to the supporting unit 3.

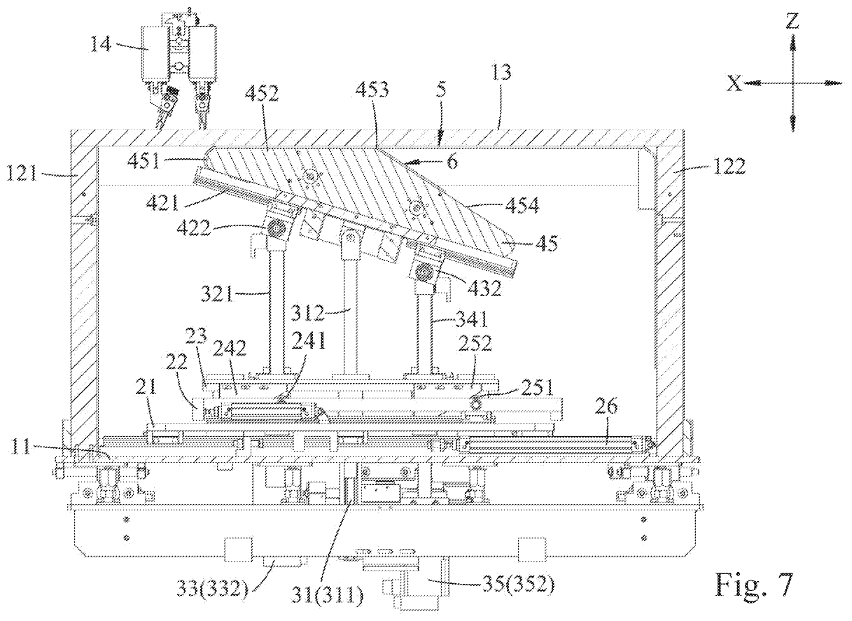

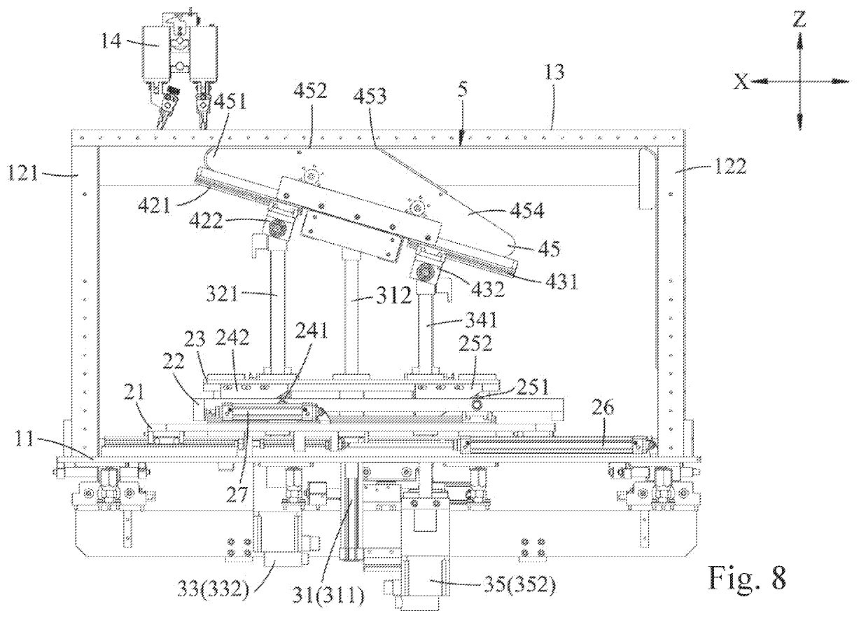

FIG. 7 shows a cross-sectional view of the screen printing machine of the first embodiment in FIG. 2 taken along line VII-VII. FIG. 8 shows one side view of the screen printing machine of the first embodiment in FIG. 1. The printing unit 4 may further include two connecting members 44 and two fixtures 45. The two fixtures 45 are respectively connected to two sides of the carrier 41 opposite in the width direction Y, and each connecting member 44 is connected between the carrier 41 and the fixture 45 corresponding thereto.

Each fixture 45 is always respectively abutted upward against the horizontal frame 13 corresponding thereto. The carrier 41 may be linked with the connecting member 44 as rotating, and thus the connecting member 44 may rotate the fixture 45 about the first axis L1. Each fixture 45 has a fixing portion 451, a first side portion 452, a central portion 453 and a second side portion 454 from left to right in order, the first side portion 452 is connected to the fixing portion 451, and the central portion 453 is connected between the first side portion 452 and the second side portion 454. The cross-sectional surface boundary of the carrier 41 perpendicular to the width direction Y may correspond to the cross-sectional surface boundary of each fixture 45.

As shown in FIGS. 3 and 7, the screen printing machine may further include two tensioning belts 5. One end of each of the tensioning belts 5 is connected to each of the two fixtures 45, and each of the tensioning belts 5 extends along each of the horizontal frames 13 corresponding thereto to the frame body 12. As each of the fixtures 45 rotates about the first axis L1, different portions of each of the tensioning belts 5 is pressed between each of the horizontal frames 13 and the fixture 45 corresponding thereto. To be more specific, each tensioning belt 5 extends upward from the fixing portion 451 of each fixture 45 corresponding thereto, toward a right side, to the second frame 122 along each of the horizontal frames 13. As each fixture 45 rotates about the first axis L1, the corresponding tensioning belt 5 may be wound on the first side portion 452, the central portion 453 and the second side portion 454.

With that one of the first motor 332 and the second motor 352 may be lifted relative to the sliding platform 23 while the other one thereof may be lowered relative to the sliding platform 23, the first supporting rod 321 and the second supporting rod 341 may rotate the carrier 41 about the first axis L1, and the carrier 41 may drive the fixture 45 to wind the tensioning belt 5. The fixture 45 moves the carrier 41 in the length direction X as tensioning the tensioning belt 5, and the fixture 45 may be changed between a first position, a second position and a third position relative to the horizontal frame 13.

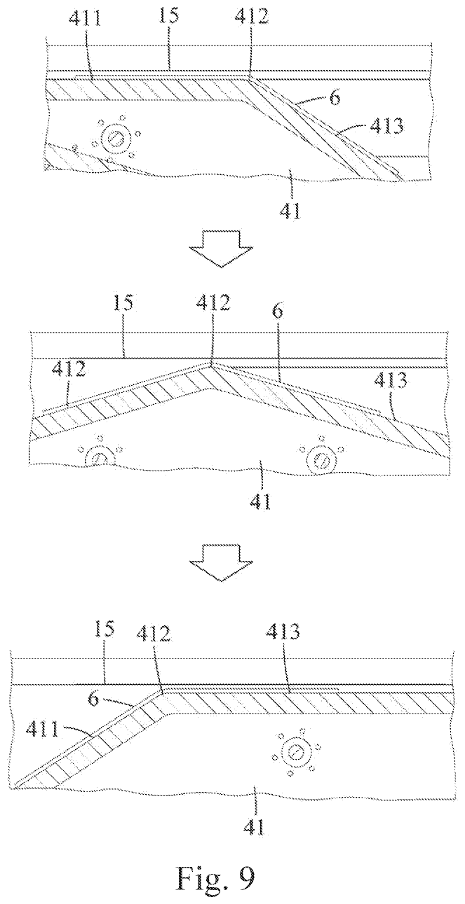

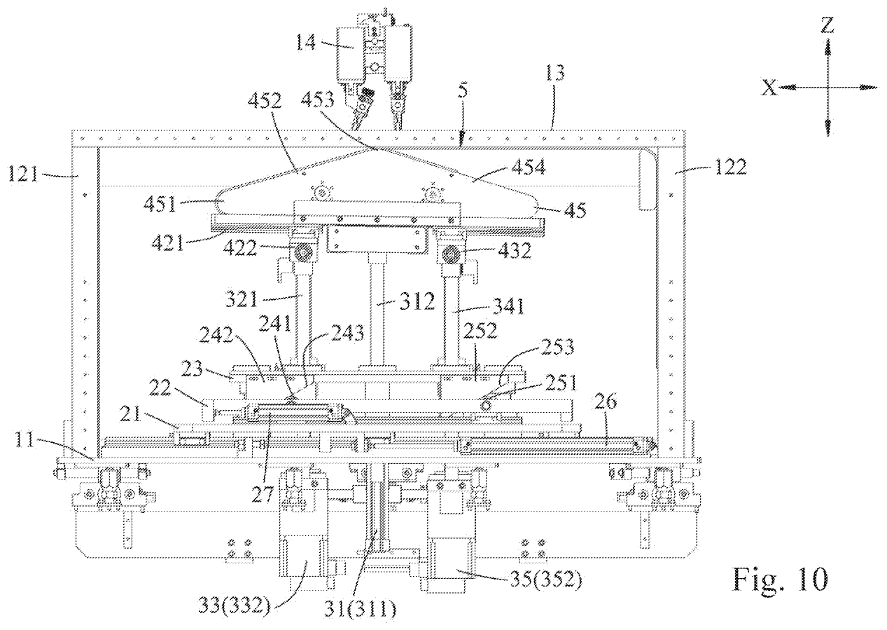

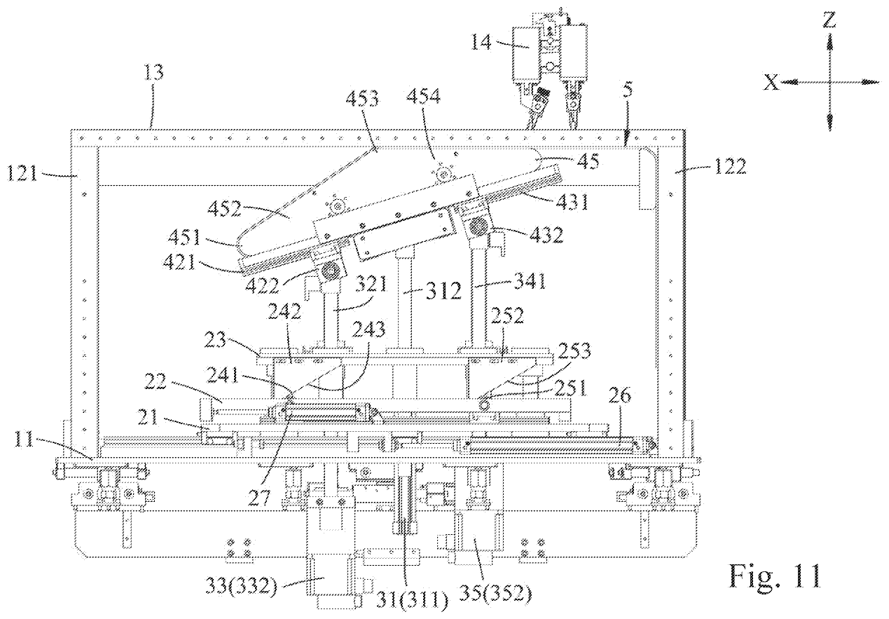

FIG. 9 shows an operating flow of the screen printing machine of the first embodiment in FIG. 1. FIG. 10 shows another side view of the screen printing machine of the first embodiment in FIG. 1. FIG. 11 shows yet another side view of the screen printing machine of the first embodiment in FIG. 1. Before printing, the first motor 332 and the second motor 352 are operated to move the carrier 41, and the carrier 41 rotates the fixture 45 to move to the first position relative to the horizontal frame 13. Subsequently, a concave portion of the to-be-printed article 6 is put downward to the carrier 41, thereby allowing the to-be-printed article 6 to abut against the first side surface 411, the central surface 412 and the second side surface 413. The carrier 41 is now in the first printing position, and the sliding platform 23 is in the first length position.

As shown in FIGS. 8 and 9, as the fixture 45 is in the first position relative to the horizontal frame 13, the first side portion 452 and one end of the central portion 453 of the fixture 45 is abutted against the tensioning belt 5 and the horizontal frame 13 corresponding thereto, and the central portion 453 and the second side portion 454 are away from the tensioning belt 5 and the horizontal frame 13 corresponding thereto. The first side surface 411 is near the screen 15, and the central surface 412 and the second side surface 413 are away from the screen 15. A first printed-surface of the to-be-printed article 6, being abutted against the first side surface 411 of the carrier 41, is near the screen 15.

As printing, the blade assembly 14 presses the screen 15 to the carrier 41 as moving downward from a left side of the carrier 41, and then move to a right side to scrape the ink off the screen 15, thereby one portion of a pattern on the screen 15 is printed on the first printed-surface of the to-be-printed article 6 that corresponds to the first side surface 411.

As shown in FIGS. 9 and 10, rotation of the first screwing rod 331 and the second screwing rod 351 may cause the carrier 41 to rotate the two fixtures 45 to respectively wind the two tensioning belt 5, and the fixture 45 moves to the second position relative to the horizontal frame 13. The carrier 41 is now in the second printing position, and the sliding platform 23 is in the second length position. As the fixture 45 is in the second position relative to the horizontal frame 13, the central portion 453 of each fixture 45 is abutted against the tensioning belt 5 and the horizontal frame 13 corresponding thereto, the first side portion 452 is away from the horizontal frame 13 corresponding thereto to allow one portion of the tensioning belt 5 to wind about the first side portion 452 and away from the horizontal frame 13, and the second side portion 454 keeps being away from the tensioning belt 5 and the horizontal frame 13 corresponding thereto. The central surface 412 is near the screen 15, and the first side surface 411 and the second side surface 413 are away from the screen 15. A second printed-surface of the to-be-printed article 6, being abutted against the central surface 412 of the carrier 41, is near the screen 15.

After which, the blade assembly 14 keeps moving to the right side, thereby another portion of the pattern on the screen 15 is printed on the second printed-surface of the to-be-printed article 6 that corresponds to the central surface 412. As shown in FIGS. 9 and 11, the first screwing rod 331 and the second screwing rod 351 are driven, the carrier 41 rotates the two fixtures 45 to respectively keep winding the two tensioning belts 5, and the fixture 45 moves to the third position relative to the horizontal frame 13. The carrier 41 is now in a third printing position, and the sliding platform 23 is in a third length position.

As the fixture 45 is in the third position relative to the horizontal frame 13, the second side portion 454 of each fixture 45 is abutted against the tensioning belt 5 and the horizontal frame 13 corresponding thereto, the first side portion 452 is away from the horizontal frame 13 corresponding thereto to allow one portion of the tensioning belt 5 to wind about the first side portion 452, the central portion 453 and the second side portion 454. The second side surface 413 of the carrier 41 is near the screen 15, and the first side surface 411 and the central surface 412 are away from the screen 15. A third printed-surface of the to-be-printed article 6, being abutted against the second side surface 413 of the carrier 41, is near the screen 15.

After which, the blade assembly 14 keeps moving to the right side, thereby a rest portion of the pattern on the screen 15 is printed on the third printed-surface of the to-be-printed article 6 that corresponds to the second side surface 413. In the embodiment, the cross-sectional surface boundary of the carrier 41 perpendicular to the width direction Y is substantially a triangle, and the second printed-surface is small, which results that the remaining time of the fixture 45 in the second position, the remaining time of carrier 41 in the second printing position and the printing time of the blade assembly 14 are short. In other various embodiments, in order to correspond to the to-be-printed article having various radius, the cross-sectional surface boundary of the carrier perpendicular to the width direction may be polygon-shaped, semicircle-shaped, circular, or a geometric configuration formed by inclined-lines or curved-lines.

Therefore, with that the movements and rotations of the carrier 41 causes the fixtures 45 to be abutted upward against the horizontal frame 13, a fixing gap is remained between the printed-surface of the to-be-printed article 6 near the screen 15, and thus a fixing deformation may be remained as the screen 15 is pressed by the blade assembly 14 toward the to-be-printed article 6, thereby ensuring that the pattern of the screen 15 will not be deformed as being printed onto the to-be-printed article 6.

In addition, the tensioning belt 5 is a non-retractable steel belt, and as the fixture 45 moves from the first position to the third position relative to the horizontal frame 13, that is the carrier 41 rotating the to-be-printed article 6 and the fixture 45, with that the fixture 45 may be restricted by the tensioning belt 5, the two first sliders 422 move relative to the two first rails 421, and the two second sliders 432 move relative to the two second rails 431, the pattern onto the to-be-printed article 6 will not be stretched or shortened in the length direction X when printing from the screen 15 to the to-be-printed article 6, thereby increasing the printing accuracy and quality.

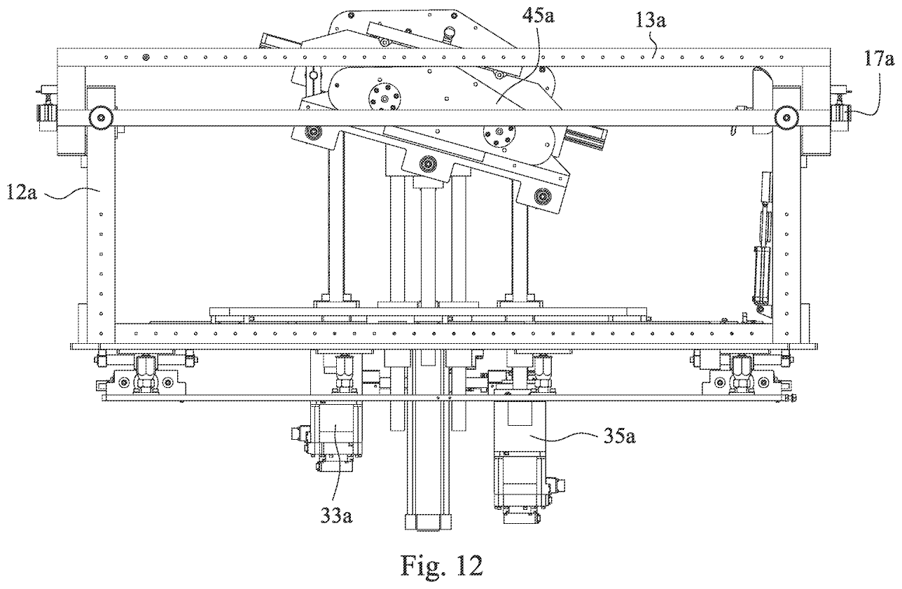

FIG. 12 shows a side view of a screen printing machine according to a second embodiment of the present disclosure. The screen printing machine of the second embodiment is similar to the screen printing machine of the first embodiment in FIGS. 1 to 11, only the differences are mentioned hereinafter, and the similar description will not be repeated.

The machine frame of the screen printing machine may include a frame body 12a, two horizontal frames 13a and at least one sensor 17a. The frame body 12a is disposed at the base. The two horizontal frames 13a are movably disposed at the frame body 12a with an interval. The at least one sensor 17a is disposed at one of the horizontal frames 13a, and the at least one sensor 17a is configured to detect a pressure on the one of the horizontal frames 13a exerted by one of the fixtures 45a. Since the horizontal frames 13a are movably disposed at the frame body 12a, as the horizontal frame 13a is pushed by the fixture 45a and is away from the frame body 12a, the sensor 17a, having a load cell structure, may detect the pressure on the horizontal frame 13a as the horizontal frame 13a moves. As the pressure is larger than a load threshold, the first driving member 33a and the second driving member 35a may be operated to lower the fixture 45a to lower the pressure. In the second embodiments, a number of the at least one sensor 17a is four, two of the sensors 17a may be disposed at two opposite sides of one of the horizontal frames 13a, and the other two of the sensors 17a may be disposed at two opposite sides of the other one of the horizontal frames 13a. Additionally, the moving unit may include a sliding platform rail disposed at the base, and the sliding platform is movably disposed at the sliding platform rail to move in the length direction.

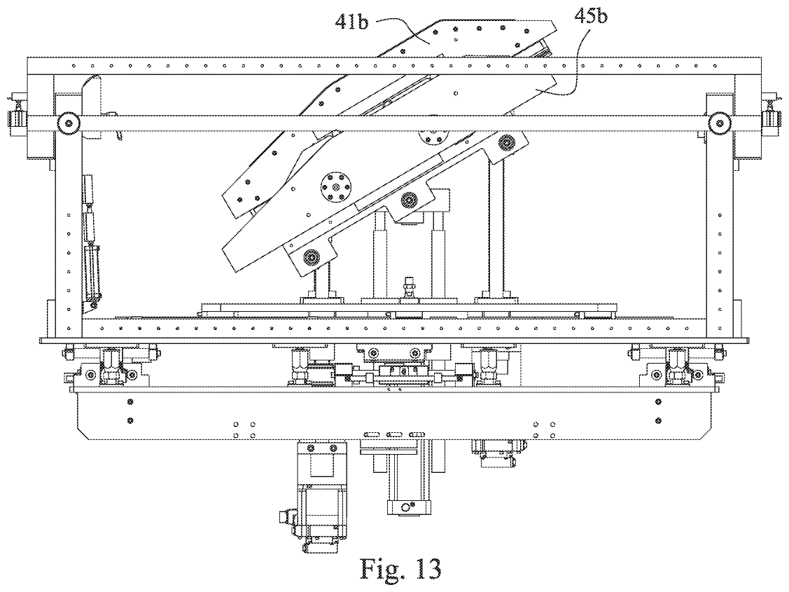

FIG. 13 shows a side view of a screen printing machine according to a third embodiment of the present disclosure, and the view angle thereof is opposite to the view angle of FIG. 12. The screen printing machine of the third embodiment is similar to the screen printing machine of the second embodiment in FIGS. 12, but the shapes of the fixture 45b and the carrier 41b are different. Precisely, the carrier 41b may sequentially include a first side surface, a first central surface, a second side surface, a second central surface, and a third side surface. The shape of the fixture 45b corresponds to the carrier 41b. Therefore, as the fixture 45b rotates to a different position, the carrier 41b may rotate to a different printing position to allow a different printed-surface of the to-be-printed article to be printed.

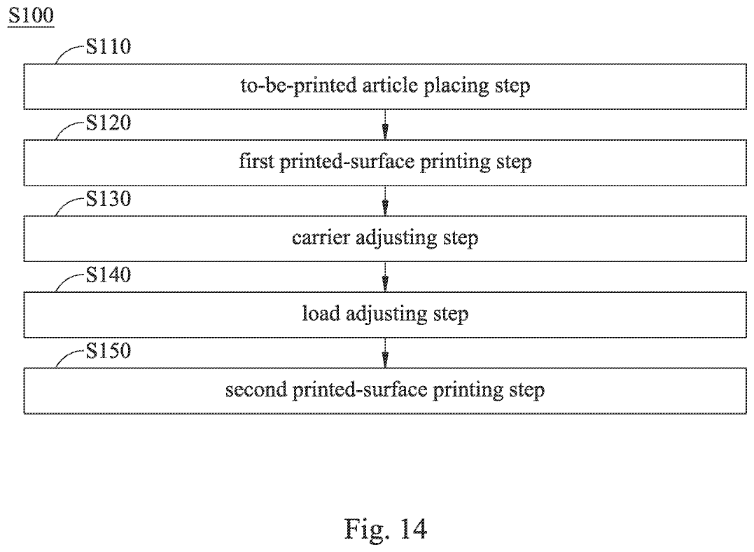

FIG. 14 shows a block flow chart of a screen printing method S100 according to a fourth embodiment of the present disclosure. The screen printing method S100 includes a to-be-printed article placing step S110, a first printed-surface printing step S120, a carrier adjusting step S130 and a second printed-surface printing step S150.

Please also refer to FIGS. 1 to 11, in the to-be-printed article placing step S110, the to-be-printed article 6 is placed at the carrier 41 of the printing unit 4 of the screen printing machine.

In the first printed-surface printing step S120, the blade assembly 14 of the screen printing machine scrapes the ink off the screen 15, and one portion of the pattern on the screen 15 is printed on the first printed-surface of the to-be-printed article 6.

In the carrier adjusting step S130, the supporting unit 3 connected to the carrier 41 is driven to rotate the carrier 41 from the first printing position to the second printing position about the first axis L1, and the sliding platform 23 is moved from the first length position to the second length position in the length direction X and is linked with the carrier 41, thereby allowing the second printed-surface of the to-be-printed article 6 to face toward the screen 15.

In the second printed-surface printing step S150, the blade assembly 14 of the screen printing machine scrapes the ink off the screen 15, and another portion of the pattern on the screen 15 is printed on the second printed-surface of the to-be-printed article 6.

To be more specific, in the carrier adjusting step S130, the first driving member 33 and the second driving member 35 may be driven to rotate the carrier 41 about the first axis L1, and the carrier 41 and the sliding platform 23 may change position in the length direction X, thereby allowing different printed-surfaces of the to-be-printed article 6 to face upward and to be printed in the second printed-surface printing step S150.

Please refer to FIG. 12, the screen printing method S100 may further include a load adjusting step S140. As the at least one sensor 17a detects that the pressure on the one of the horizontal frames 13a exerted by one of the fixtures 45a exceeds the load threshold, the supporting unit is driven to lower the carrier to allow the pressure to be smaller than the load threshold. Therefore, over loading on the horizontal frame 13a as the fixture 45a is abutted thereagainst may be avoided.

It is noted that, the load adjusting step S140 may be performed any time and not limited to sequence of FIG. 14. In addition, as a number of the printed-surfaces of the to-be-printed article 6 is equal to or larger than 3, the carrier adjusting step S130 may be performed after the second printed-surface printing step S150 again, and a third printed-surface printing step may be performed.

To sum up, in the screen printing machine of the present disclosure, with that the carrier may rotate about the first axis, the fixture is allowed to switch between the first position, the second position and the third position relative to the fixture. Moreover, with that the tensioning belt restricts the fixture, different printed-surfaces of the to-be-printed article may be rotated to face upward, thereby allowing the to-be-printed article having various radius to be printed. In addition, the present disclosure allows the pattern on the screw to be fully and accurately print to the to-be-printed article having a curved shape, and the accuracy of printing on the to-be-printed article having various radius may be increased.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure covers modifications and variations of this disclosure provided they fall within the scope of the following claims.

What is claimed is:

1. A screen printing machine, comprising:
a machine frame, comprising:
a base;
a blade assembly located above the base; and
a screen located between the blade assembly and the base;
a moving unit disposed at the base and comprising a sliding platform, wherein the sliding platform is movable in a length direction of the machine frame;
a supporting unit disposed at the sliding platform; and
a printing unit comprising a carrier, wherein the carrier is located between the screen and the supporting unit and is connected to the supporting unit;
wherein when the supporting unit drives the carrier to rotate from a first printing position to a second printing position about a first axis, the sliding platform moves from a first length position to a second length position in the length direction.

2. The screen printing machine of claim 1, wherein the supporting unit comprising:
a first supporting member penetrating the sliding platform and pivotally connected to the carrier;
a first driving member disposed at the sliding platform and being elevatable relative to the sliding platform in a height direction of the machine frame;
a second supporting member penetrating the sliding platform and pivotally connected to the carrier, the second supporting member is spaced apart from the first supporting member in the length direction;
a second driving member disposed at the sliding platform and being elevatable relative to the sliding platform in the height direction;
wherein the first driving member is lowered relative to the sliding platform to lower the first supporting member relative to the sliding platform, and the second driving member is lifted relative to the sliding platform to lift the second supporting member relative to the sliding platform, thereby allowing the carrier to rotate from the first printing position to the second printing position.

3. The screen printing machine of claim 2, wherein the supporting unit further comprises:
a central supporting member penetrating the sliding platform and pivotally connected to a center of the carrier.

4. The screen printing machine of claim 2, wherein the printing unit further comprises:
a first sliding member, comprising:
two first rails disposed at the carrier with an interval in a width direction of the machine frame;
two first sliders respectively disposed at the two first rails; and
a first pivoting rod rotably connected between the two first sliders and being configured for the first supporting member to be disposed thereon; and
a second sliding member, comprising:
two second rails disposed at the carrier with an interval in the width direction, each of the second rails being spaced apart from each of the first rails in the length direction;
two second sliders respectively disposed at the two second rails; and
a second pivoting rod rotably connected between the two second sliders and being configured for the second supporting member to be disposed thereon.

5. The screen printing machine of claim 1, wherein the machine frame further comprises:
a frame body disposed at the base;
two horizontal frames movably disposed at the frame body with an interval; and
at least one sensor disposed at one of the horizontal frames;
wherein the printing unit further comprises two fixtures respectively connected to two sides of the carrier opposite in a width direction of the machine frame, the two fixtures are always respectively abutted against the two horizontal frames, and the at least one sensor is configured to detect a pressure on the one of the horizontal frames exerted by one of the fixtures.

6. The screen printing machine of claim 5, wherein the at least one sensor has a load cell structure.

7. The screen printing machine of claim 5, further comprising two tensioning belts, wherein one end of each of the tensioning belts is connected to each of the two fixtures, each of the tensioning belts extends along each of the horizontal frames corresponding thereto to the frame body, and as each of the fixtures rotates about the first axis, different portions of each of the tensioning belts is pressed between each of the horizontal frames and the fixture corresponding thereto.

8. A screen printing method, comprising:
a to-be-printed article placing step, wherein a to-be-printed article is placed at a carrier of a printing unit of a screen printing machine;
a first printed-surface printing step, wherein a blade assembly of the screen printing machine scrapes an ink off a screen, and one portion of a pattern on the screen is printed on a first printed-surface of the to-be-printed article;
a carrier adjusting step, wherein a supporting unit connected to the carrier is driven to rotate the carrier from a first printing position to a second printing position about a first axis, and a sliding platform disposed at a machine frame is moved from a first length position to a second length position in a length direction and is linked with the carrier, thereby allowing a second printed-surface of the to-be-printed article to face toward the screen; and
a second printed-surface printing step, wherein the blade assembly of the screen printing machine scrapes the ink off the screen, and another portion of the pattern on the screen is printed on the second printed-surface of the to-be-printed article.

9. The screen printing method of claim 8, wherein the printing unit further comprises two fixtures respectively connected to two sides of the carrier opposite in a width direction, the screen printing machine further comprises two tensioning belts, one end of each of the two tensioning belts is connected to each of the two fixtures, and in the carrier adjusting step, each of the tensioning belts tensions each of the fixtures, thereby allowing the two fixtures to be always respectively abutted against two horizontal frames of the machine frame.

10. The screen printing method of claim 9, further comprising a load adjusting step, wherein the machine frame further comprises a frame body and at least one sensor, the two horizontal frames are movably disposed at the frame body with an interval, the at least one sensor is disposed at one of the horizontal frame, and as the at least one sensor detects that a pressure on the one of the horizontal frames exerted by one of the fixtures exceeds a load threshold, the supporting unit is driven to lower the carrier to allow the pressure to be smaller than the load threshold.
